(19) United States
(12) Patent Application Publication
(10) Pub. No.: US 2002/0078156 A1
(43) Pub. Date: Jun. 20, 2002

(54) Display data transmitting method for mobile terminal

(75) Inventor: Duck-Ho Choi, Yongin-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/902,419

(22) Filed: Jul. 10, 2001

(30) Foreign Application Priority Data
Dec. 15, 2000 (KR) 76928/2000

(51) Int. Cl. G06F 15/16

(52) U.S. Cl. 709/206; 709/230

(57) ABSTRACT

The present invention pertains to a method of storing data displayed on a display and transmitting the data in a mobile terminal. Upon request of capturing of the displayed data from a user, the mobile terminal stores data displayed on the display as display data and determines whether the display data is text data or graphic data. If the display data is text data, the mobile terminal transmits the display data by a predetermined text transmission function. If the display data is graphic data, the mobile terminal transmits the display data by a predetermined graphic transmission function.

### PRIORITY

This application claims priority to an application entitled “Display Data Transmitting Method for Mobile Terminal” filed in the Korean Industrial Property Office on Dec. 15, 2000 and assigned Serial No. 2000-76928, the contents of which are hereby incorporated by reference.

### BACKGROUND OF THE INVENTION

1. Field of the Invention

The present invention relates generally to a mobile terminal, and in particular, to a method of transmitting data displayed on the screen of a mobile terminal to a communication network.

2. Description of the Related Art

A mobile terminal is usually provided with additional functions including an SMS (Short Message Service) and an E-mail (electronic-mail) function as well as a telephone call function. An advanced mobile terminal even transmits a data file read from an external device like a PC (personal computer) to a different communication network and offers a data communication function such as Internet browsing.

As mobile communication technology has been developed, data transmission/reception is becoming commonplace in mobile terminals. By this function, users transmit/receive addresses, telephone numbers, and notes. For this purpose, a mobile terminal is so configured that displayed data is stored in an internal memory to be read when a user wants. However, in the case where the user is to transmit the displayed data to another user, he would memorize it or take a note of it and then make a text message about the displayed data for transmission by the SMS or E-mail.

FIG. 1 is a flowchart illustrating a conventional display data transmitting procedure.

Referring to FIG. 1, a user brings up an intended screen by selection of menu items and writes down or memorizes data displayed on the screen in step S110. Then, he terminates the current menu in step S120 and enters a data transmission mode for an SMS or an E-mail in step S130. In step S140, the user forms a new text message based on his notes or his memory. The mobile terminal transmits the text message in a known procedure in step S150.

As described above, since the conventional mobile terminal is incapable of capturing specific display data and transmitting it to a destination, the user must form a text message relying on his memory or notes and transmit it, resulting in the inconvenience of forming the text message and in manipulation complexity of the keys on the keypad.

### SUMMARY OF THE INVENTION

It is, therefore, an object of the present invention to provide a method of capturing data displayed on a screen and transmitting the captured display data to a communication network (e.g., a base station) in a mobile terminal.

It is another object of the present invention to provide a method of capturing particular data displayed on a screen and transmitting the display data to a different user by an SMS, an E-mail, or other data communication functions in a mobile terminal.

The foregoing and other objects are achieved by a method of transmitting data displayed on a display in a mobile terminal.

According to one aspect of the present invention, upon request for capturing the displayed data from a user, the mobile terminal stores data displayed on the display as display data and determines whether the display data is text data or graphic data. If the display data is text data, the mobile terminal transmits the display data by a predetermined text transmission function. If the display data is graphic data, the mobile terminal transmits the display data by a predetermined graphic transmission function. After the captured data is transmited, the user determines whether the captured data is deleted or saved.

According to another aspect of the present invention, upon request for capturing the displayed data from a user, the mobile terminal stores data displayed on the display as display data, enters a transmission function select mode and displays a plurality of available transmission functions as menu items, and transmits the display data by a selected transmission function upon receipt of a selection command from the user in the transmission function select mode.

According to a further aspect of the present invention, the mobile terminal stores data displayed on the display as display data and determines whether the display data is text data or graphic data. If the display data is text data, the mobile terminal enters a text data transmission function select mode and displays a plurality of available text transmission functions as menu items. If the display data is graphic data, the mobile terminal enters a graphic data transmission function select mode and displays a plurality of available graphic transmission functions as menu items. Upon receipt of a selection command from the user in the text data transmission function select mode or the graphic data transmission function select mode, the mobile terminal transmits the display data by a selected transmission function.

### BRIEF DESCRIPTION OF THE DRAWINGS

The above and other objects, features and advantages of the present invention will become more apparent from the following detailed description when taken in conjunction with the accompanying drawings in which:

FIG. 1 is a flowchart illustrating a conventional display data transmitting procedure;

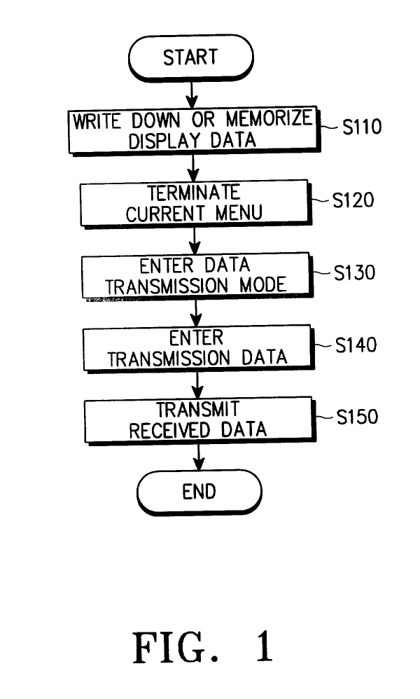

FIG. 2 is a schematic block diagram of a mobile terminal to which the present invention is applied;

FIG. 3 is a flowchart illustrating an embodiment of a display data transmitting procedure according to the present invention;

FIG. 4 is a flowchart illustrating a text transmitting procedure according to the present invention;

FIG. 5 is a flowchart illustrating another embodiment of the display data transmitting procedure according to the present invention; and

FIG. 6 is a flowchart illustrating a third embodiment of the display data transmitting procedure according to the present invention.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail since they would obscure the invention in unnecessary detail.

A display data transmitting method according to the present invention is applicable to a mobile terminal that has a display and supports one of an SMS, an E-mail, and a data communication function.

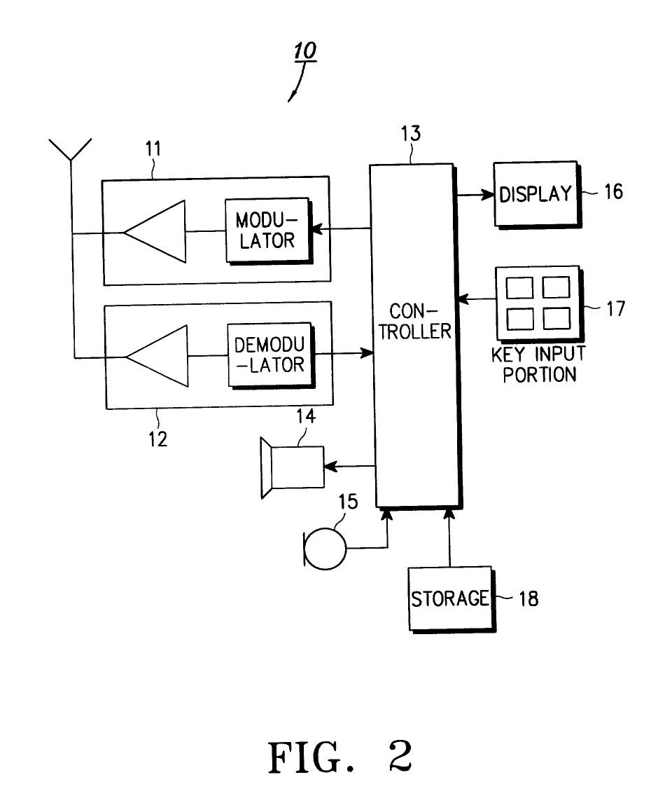

FIG. 2 is a schematic block diagram of a mobile terminal to which the present invention is applied.

Referring to FIG. 2, to exchange signals with a mobile communication system including a base station, an MSC (Mobile Switching Center), and a data communication center (e.g., an SMS message center or an Internet Interworking Function Center), a mobile terminal 10 is comprised of a transmitter 11 with a modulator and a transmission amplifier and a receiver 12 with a reception amplifier and a demodulator.

A display 16 can be an LCD (Liquid Crystal Display) and outputs display messages generated in the mobile terminal, particularly transmission/reception text messages and messages for E-mail and data communication. A key input portion 17 can be, for instance, a keypad or touch pad and includes a plurality of digit/character keys, function keys for a user interface, and keys for speech.

Including a digital processor (DSP), a microprocessor, and other circuits, a controller 13 controls the transmitter 11 and the receiver 12, for allowing the user to conduct a voice call with another user through a speaker 14 and a microphone 15. In particular, the controller 13 enables data communication via the display 16 and the key input portion 17 and performs a control operation for display data transmission according to embodiments of the present invention.

A storage 18 includes a ROM (Read Only Memory) for storing a plurality of operation programs and related data, a RAM (Random Access Memory), and a voice memory. The storage 18 stores particularly an operation program for executing display data transmission and has a transmission data storing area (or a separate procured memory) for temporarily storing display data to be transmitted according to the embodiments of the present invention.

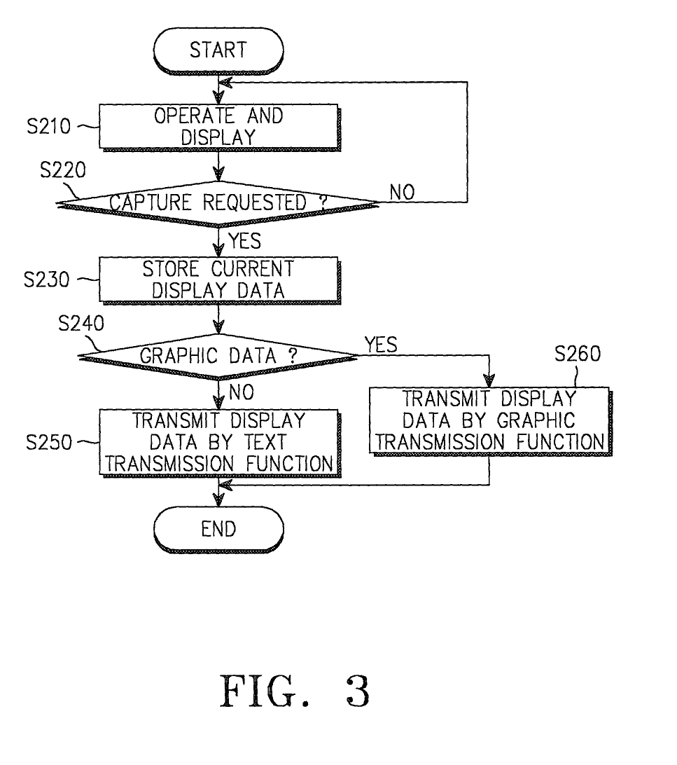

FIG. 3 is a flowchart illustrating an embodiment of a display data transmission procedure according to the present invention.

Referring to FIG. 3, the mobile terminal displays messages generated during transmission/reception of SMS messages or data communication on the display 16 and the user brings up a screen that shows, for example, an intended SMS message or directory by selection of menu items in step S210. While the screen is displayed, the user enters a predetermined key, such as a confirmation key or a key designated during manufacture of the mobile terminal exclusively for capturing, for a predetermined time or longer in order to request capturing of the displayed data.

Upon request of capturing the displayed data in step S220, the mobile terminal stores the data displayed on the current screen as display data in a predetermined storing area or a separately procured memory in step S230. State indicators such as an antenna bar and icon images on the screen are preferably excluded from the display data.

In step S240, the controller 13 of the mobile terminal determines whether the display data is text data or graphic data, because graphic data of a relatively great size should be transmitted in a different way from that for text data. For example, the controller can determine the type of the display data by comparing the size of the display data with a predetermined threshold. If the size of the display data is greater than the threshold, the display data is considered graphic data and otherwise, it is considered text data. Since the difference in size between text data and graphic data is great, the threshold is set appropriately based on the difference so that they are readily discriminated.

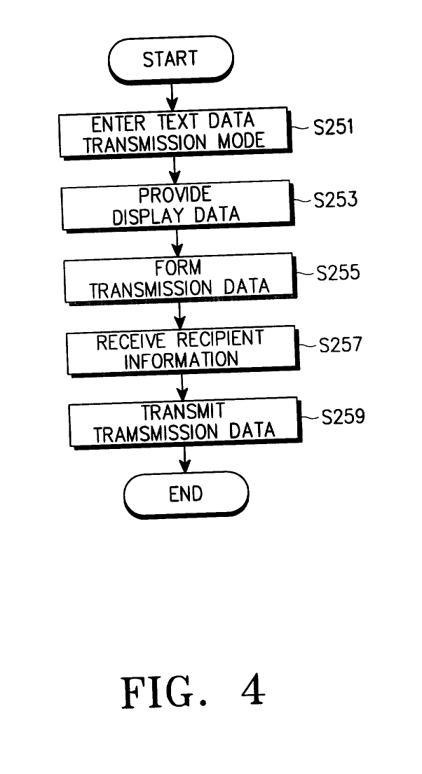

In the case of text data, the mobile terminal transmits the display data by use of an available text transmission function, for example, an SMS or E-mail in step S250. Step S250 will be described in detail referring to FIG. 4. In the case of graphic data, the display data is transmitted by an available graphic transmission function, for example, a data communication function in step S260. That is, the mobile terminal connects a call to the Internet Interworking Function Center in a call origination process and uploads the display data on the web.

FIG. 4 is a flowchart illustrating a text transmission procedure according to the present invention. The mobile terminal enters a text data transmission mode in step S251 and provides a screen with the display data basically therein in step S253. The user writes a transmission message by editing/deleting/adding the display data in the same manner as a general text message or an E-mail. When the user presses the key designated for confirmation, the mobile terminal provides a menu that prompts the user to enter information about a recipient, for example, a telephone number or an E-mail address and receives the recipient information in step S257. In step S259, the mobile terminal transmits the transmission message together with the recipient information to a base station on a radio channel. Then, the base station transmits the recipient information to an MSC. The MSC converts the transmission message to an appropriate form by analyzing the recipient information and transmits it to the recipient.

While the mobile terminal determines the type of display data and automatically transmits the display data based on the type in the first embodiment of the present invention, the user can determine which data transmission function to use for the display data in a second embodiment of the present invention.

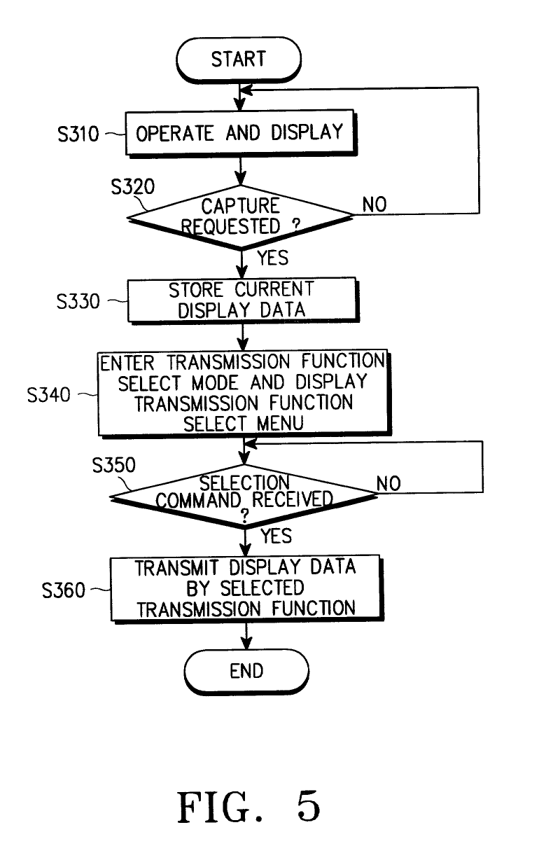

FIG. 5 is a flowchart illustrating another embodiment of the display data transmitting procedure according to the present invention. It is to be noted that the operation of FIG. 5 similar to the first embodiment will not be described.

Referring to FIG. 5, the mobile terminal displays messages generated during execution of a function on the display 16 in step S310. Upon request of capturing of displayed data from the user in step S320, the mobile terminal stores the displayed data as display data in step S330. In step S340, the mobile terminal enters a transmission function select mode and displays a plurality of available transmission functions as menu items. When the user enters a command that selects his intended transmission function in step S350, the mobile terminal transmits the display data by the selected transmission function in step S360.

An example select menu is shown below.

[transmission function select menu]

1. SMS

2. E-mail

3. data communication

When the user presses a key, for example the digit key “1”, and a confirmation key as a command for selecting an intended transmission function, the mobile terminal transmits the display data by the SMS. The procedure of transmitting the display data by the selected transmission function is performed in the same manner as in the first embodiment of the present invention.

As a contemplated third embodiment of the present invention the mobile terminal determines the type of display data and then displays only appropriate transmission functions as menu items.

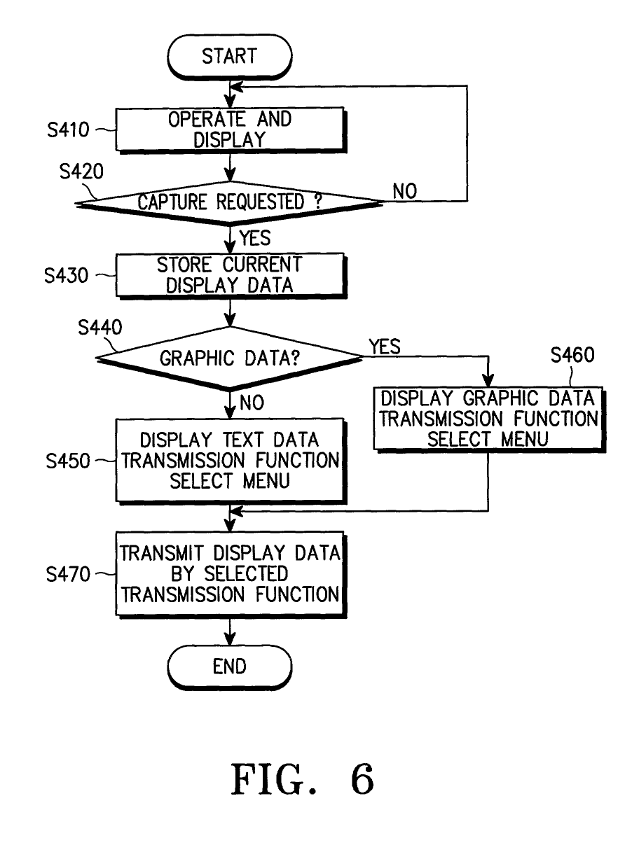

FIG. 6 is a flowchart illustrating a third embodiment of the display data transmitting procedure according to the present invention. Only the features of the third embodiment of the present invention will be described herein as compared to the first and second embodiments.

Referring to FIG. 6, the mobile terminal displays messages generated during execution of a function on the display 16 in step S410. Upon request of capturing of displayed data from the user in step S420, the mobile terminal stores the displayed data as display data in step S430. In step S440, the mobile terminal determines whether the display data is text data or graphic data.

In the case of text data, the mobile terminal displays a text transmission function select menu in step S450. On the other hand, in the case of graphic data, the mobile terminal displays a graphic transmission function select menu in step S460.

When the user enters a command that selects his intended transmission function in step S450 or step S460, the mobile terminal displays the display data by the selected transmission function in step S470.

In accordance with the present invention as described above, a mobile terminal (portable phone) with an SMS function or a data communication function captures particular data displayed on a display and transmits the data to a recipient over a communication network (through a base station) by the SMS, the data communication function, browsing, or E-mail. Therefore, the time required to write a transmission message is saved and user convenience is increased.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of transmitting display data in a mobile terminal having a display, comprising the steps of:
storing data displayed on the display as display data upon request for capturing the displayed data from a user;
determining whether the display data is text data or graphic data;
transmitting the display data by a predetermined text transmission function if the display data is text data; and
transmitting the display data by a predetermined graphic transmission function if the display data is graphic data.

2. The method of claim 1, wherein the text transmission function is at least one of an SMS function, an E-mail function, and a data communication function.

3. The method of claim 1, wherein the graphic transmission function is a data communication function.

4. The method of claim 1, wherein the display data transmission step comprises the steps of:
receiving information about a recipient from the user by the mobile terminal;
transmitting the display data along with the recipient information to a base station by the mobile terminal;
transmitting the display data along with the recipient information to a mobile switching center (MSC) by the base station; and
analyzing the recipient information, converting the display data, and transmitting the display data to the recipient by the MSC.

5. A method of transmitting display data in a mobile terminal having a display, comprising the steps of:
storing data displayed on the display as display data upon request for capturing of the displayed data from a user;
entering a transmission function select mode and displaying a plurality of available transmission functions as menu items; and
transmitting the display data by a selected transmission function upon receipt of a selection command from the user in the transmission function select mode.

6. The method of claim 5, wherein the transmission functions are at least one of an SMS function, an E-mail function, and a data communication function.

7. A method of transmitting display data in a mobile terminal having a display, comprising the steps of:
storing data displayed on the display as display data upon request for capturing the displayed data from a user;
determining whether the display data is text data or graphic data;
entering a text data transmission function select mode and displaying a plurality of available text transmission functions as menu items if the display data is text data;
entering a graphic data transmission function select mode and displaying a plurality of available graphic transmission functions as menu items if the display data is graphic data; and
transmitting the display data by a selected transmission function upon receipt of a selection command from the user in the text data transmission function select mode or the graphic data transmission function select mode.

8. The method of claim 7, wherein the text transmission functions are one of an SMS function, an E-mail function, and a data communication function.

9. The method of claim 7, wherein the graphic transmission functions include a data communication function.

10. A method of transmitting display data in a mobile terminal having a display, comprising the steps of:
storing data displayed on the display as display data upon request for capturing the displayed data from a user;
requesting the user to enter information about a recipient that the display data is destined to; and
transmitting the display data to the recipient.

11. A method of transmitting display data in a mobile terminal having a display, comprising the steps of:
determining whether a request for capturing display data has been received from a user;
storing data displayed on the display as display data upon request of capturing of the displayed data from the user; and
transmitting the display data to a recipient upon receipt of a transmission request.
